(19) United States
(12) Patent Application Publication
(10) Pub. No.: US 2016/0251888 A1
(43) Pub. Date: Sep. 1, 2016

(54) DOOR OPENING AND CLOSING APPARATUS FOR VEHICLE

(71) Applicant: AISIN SEIKI KABUSHIKI KAISHA, Kariya-shi, Aichi-ken (JP)

(72) Inventors: Sadayuki MAKINO, Nagoya-shi (JP); Kenta MORI, Kariya-shi (JP); Yuki ISHIGURO, Kariya-shi (JP)

(73) Assignee: AISIN SEIKI KABUSHIKI KAISHA, Kariya-shi, Aichi-ken (JP)

(21) Appl. No.: 15/031,076

(22) PCT Filed: Oct. 20, 2014
(86) PCT No.: PCT/JP2014/077859

§ 371 Date: Apr. 21, 2016

(30) Foreign Application Priority Data
Oct. 28, 2013 (JP) 2013-223481

(51) Int. Cl. E05F 15/632; E05F 15/643; E05B 85/26; E05B 85/24; E05B 81/06; E05B 83/40

(52) U.S. Cl. CPC E05F 15/632; E05B 81/06; E05B 83/40; E05B 85/26; E05B 85/243; E05F 15/643; E05Y 2400/30; E05Y 2900/531

(57) ABSTRACT

A door opening and closing apparatus for a vehicle includes a rear lock, an output lever connected to the rear lock, a mechanical second clutch and an interlocking mechanism. The output lever rotates in one direction for operating the rear lock to bring the slide door from the half closed state to the fully closed state, and rotates in the other direction to bring the slide door from the fully closed state to the half closed state. The interlocking mechanism switches the second clutch to a connection state by interlocking with a state of the slide door positioned in a range from the fully closed state to the half closed state and switches the second clutch to a disconnection state by interlocking with a state of the slide door positioned in a range where the slide door is opened relative to the half closed state.

### TECHNICAL FIELD

This invention relates to a door opening and closing apparatus for a vehicle.

### BACKGROUND ART

A known door opening and closing apparatus for a vehicle is disclosed in Patent document 1. The apparatus disclosed in the aforementioned document includes a wire drum, a swing arm, first and second clutches and the like. In the apparatus, with a rotation of the wire drum, one of and the other of a door opening cable and a door closing cable are reeled in and out respectively to thereby open and close a vehicle door serving as a slide door. In addition, with a rotation of the swing arm, a pawl (ratchet) disengages from a latch of a door lock that holds the vehicle door in a fully closed state. The first clutch is disposed between the wire drum and a first worm wheel meshed with a cylinder worm serving as an output shaft of a motor. The second clutch is disposed between the swing arm and a second worm wheel meshed with the output shaft. The first clutch and the second clutch are controlled to turn on and off so that the rotation of the wire drum and the rotation of the swing arm may be achieved while the single motor is continuously rotating.

In Patent document 1, an electromagnetic clutch which is electrically controlled to turn on and off is employed as the second clutch. The mass of the electromagnetic clutch is large, which is a cause of increasing the mass of the entire apparatus.

### DOCUMENT OF PRIOR ART

### Patent Document

Patent document 1: Japanese Patent 3694493

### OVERVIEW OF INVENTION

### Problem to be Solved by Invention

An object of the present invention is to provide a door opening and closing apparatus for a vehicle that may decrease in weight.

### Means for Solving Problem

According to a first aspect of the present invention, in order to solve the aforementioned drawbacks, a door opening and closing apparatus for a vehicle includes a door lock configured to hold a vehicle door in a fully closed state or a half closed state, an output member connected to the door lock and rotating in one direction for operating the door lock to Brian the vehicle door from the half closed state to the fully closed state, the output member rotating in the other direction for operating the door lock to bring the vehicle door from the fully closed state to the half closed state, a motor, and a locking clutch serving as a mechanical clutch and connecting and disconnecting a rotation transmission between the motor and the output member is provided. The door opening and closing apparatus for the vehicle is configured to electrically open and close the vehicle door in a range from an open state to the half closed state. The door opening and closing apparatus for the vehicle includes an interlocking mechanism switching the locking clutch to a connection state of the rotation transmission by interlocking with a state of the vehicle door positioned in a range from the fully closed state to the half closed state and switching the locking clutch to a disconnection state of the rotation transmission by interlocking with a state of the vehicle door positioned in a range where the vehicle door is opened relative to the half closed state.

According to the aforementioned construction, in a case where the vehicle door reaches the half closed state with the closing operation of the vehicle door which is electrically performed from the open state, the locking clutch is switched to the connection state of the rotation transmission by the interlocking mechanism. Accordingly, in a case where the output member is rotated by the motor, the door lock is operated so as to bring the vehicle door from the half closed state to the fully closed state. In the fully closed state of the vehicle door, when the output member is rotated by the motor, the door lock is operated so as to bring the vehicle door from the fully closed state to the half closed state. In association with the above, when the vehicle door reaches the half closed state, the locking clutch is switched to the disconnection state of the rotation transmission by the interlocking mechanism. Then, the opening operation of the vehicle door which is electrically performed is started. Accordingly, the mechanical locking clutch is switched to the connection state or the disconnection state of the rotation transmission by the interlocking mechanism based on the state of the vehicle door. As a result, the door opening and closing apparatus for the vehicle decreases in weight as compared to a case where an electromagnetic clutch is employed.

It is favorable that the interlocking mechanism is provided with a lost motion that cancels an operation relative to the locking clutch which is switched to the connection state of the rotation transmission in a case where the vehicle door is opened and closed between the fully closed state and the half closed state.

According to the aforementioned construction, the interlocking mechanism is inhibited from keeping operating relative to the locking clutch in the connection state of the rotation transmission by interlocking with the opening and closing operation of the vehicle door between the fully closed state and the half closed state. As a result, the operation of the locking clutch is stabilized.

It is favorable that the door opening and closing apparatus for the vehicle includes a pulley rotating to move a rope member for opening and closing the vehicle door and an opening and closing clutch connecting and disconnecting a rotation transmission between the motor and the pulley.

According to the aforementioned construction, in a case where the opening and closing clutch is switched to the connection state of the rotation transmission between the motor and the pulley, the pulley related to the opening and closing operation of the vehicle door may be rotated by the motor which is shared with the output member. Then, a transition from a state where the pulley is rotated so as to close the vehicle door to a state where the output member is rotated for operating the door lock so that the vehicle door is brought to the fully closed state from the half closed state may be easily performed.

It is favorable that the door lock includes a latch provided to be rotatable at one of a vehicle body and the vehicle door, the latch holding the vehicle door in the fully closed state by engaging with a striker which is fixed to the other of the vehicle body and the vehicle door in a case where the latch is arranged at a fully latched position, the latch holding the vehicle door in the half closed state by engaging with the striker in a case where the latch is arranged at a half latched position, and a pawl restricting a rotation of the latch arranged at the fully latched position or the half latched position. The interlocking mechanism switches the locking clutch between the connection state and the disconnection state of the rotation transmission by interlocking with the rotation of the latch.

According to the aforementioned construction, the interlocking mechanism is configured to switch the locking clutch by utilizing the existing latch between the connection state and the disconnection state of the rotation transmission. Thus, a construction of the interlocking mechanism may be simplified.

It is favorable that the door lock includes a latch provided to be rotatable at one of a vehicle body and the vehicle door, the latch holding the vehicle door in the fully closed state by engaging with a striker which is fixed to the other of the vehicle body and the vehicle door in a case where the latch is arranged at a fully latched position, the latch holding the vehicle door in the half closed state by engaging with the striker in a case where the latch is arranged at a half latched position, and a pawl restricting a rotation of the latch arranged at the fully latched position or the half latched position. The interlocking mechanism includes an interlocking lever provided to be rotatable at the vehicle body or the vehicle door including the latch, the interlocking lever rotating on a basis of an engagement position of the striker relative to the latch. The interlocking mechanism switches the locking clutch between the connection state and the disconnection state of the rotation transmission by interlocking with a rotation of the interlocking lever.

According to the aforementioned construction, the locking clutch is switchable between the connection state and the disconnection state of the rotation transmission by the interlocking mechanism which utilizes the interlocking lever independently provided from the latch. Thus, degree of freedom of configuration or arrangement of the interlocking mechanism, for example, improves.

It is favorable that the interlocking mechanism includes a link mechanism provided between a vehicle body and the vehicle door, the link mechanism operating on a basis of a clearance between the vehicle body and the vehicle door, and the interlocking mechanism switches the locking clutch between the connection state and the disconnection state of the rotation transmission by interlocking with an operation of the link mechanism.

According to the aforementioned construction, the interlocking mechanism may switch the locking clutch between the connection state and the disconnection state, without being restricted by the door lock, by the usage of the link mechanism provided between the vehicle body and the vehicle door.

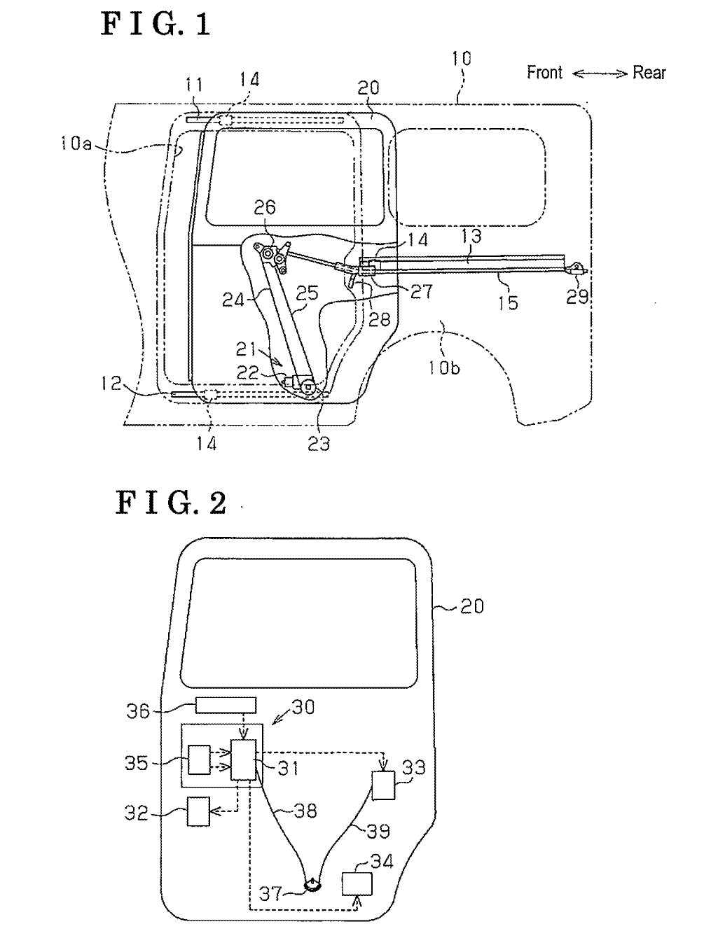

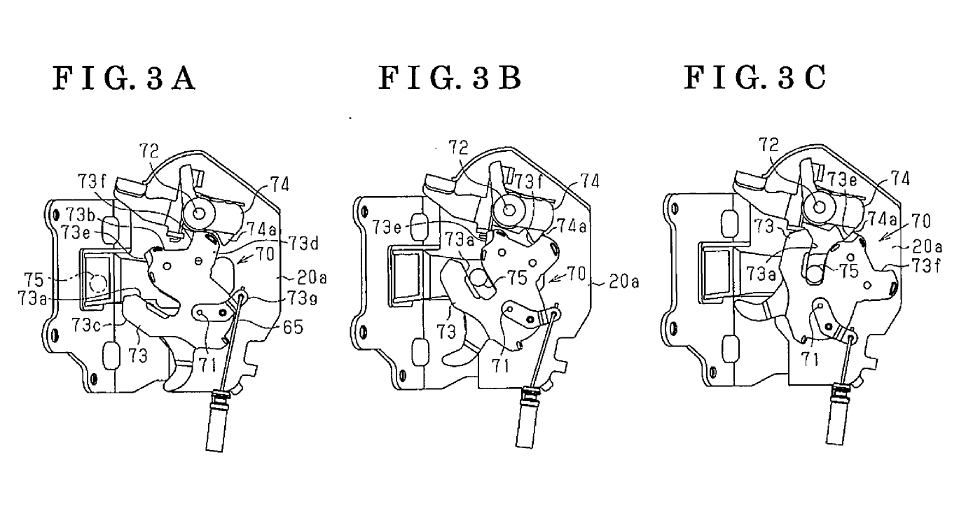

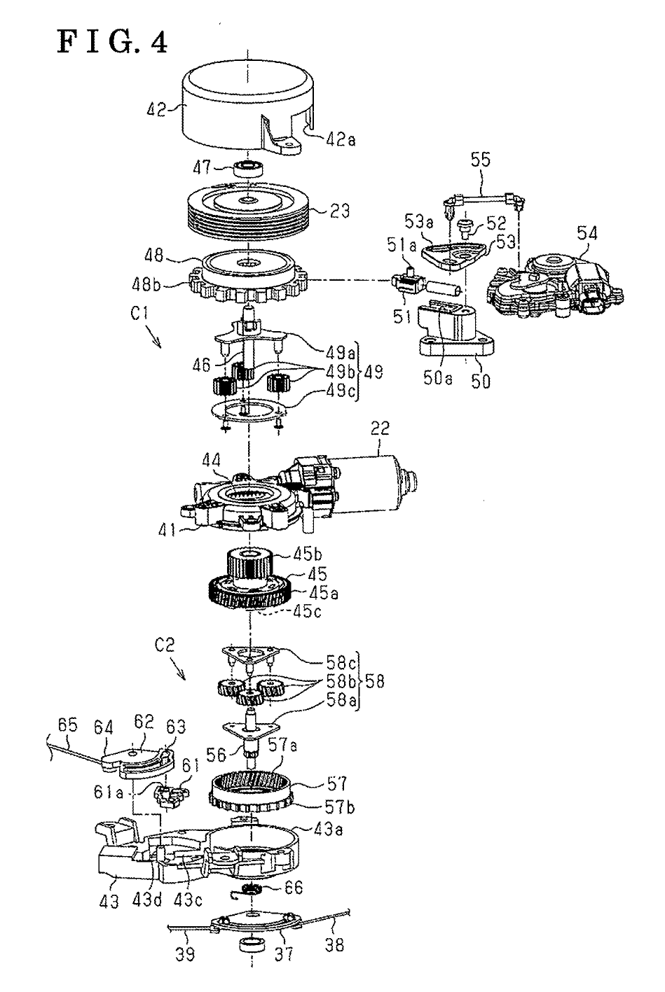

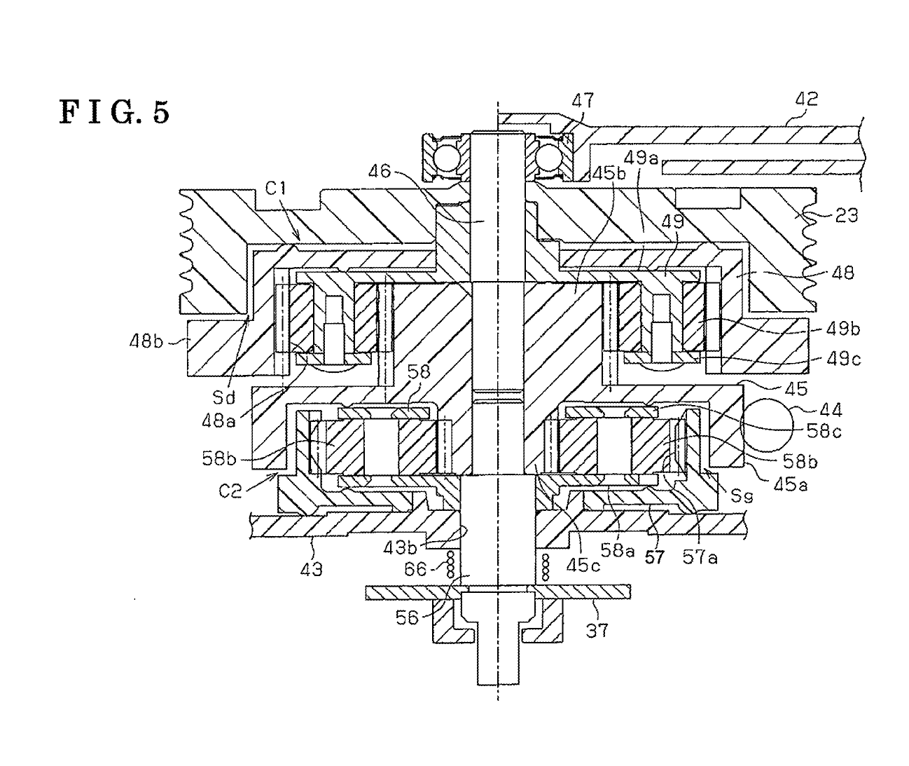

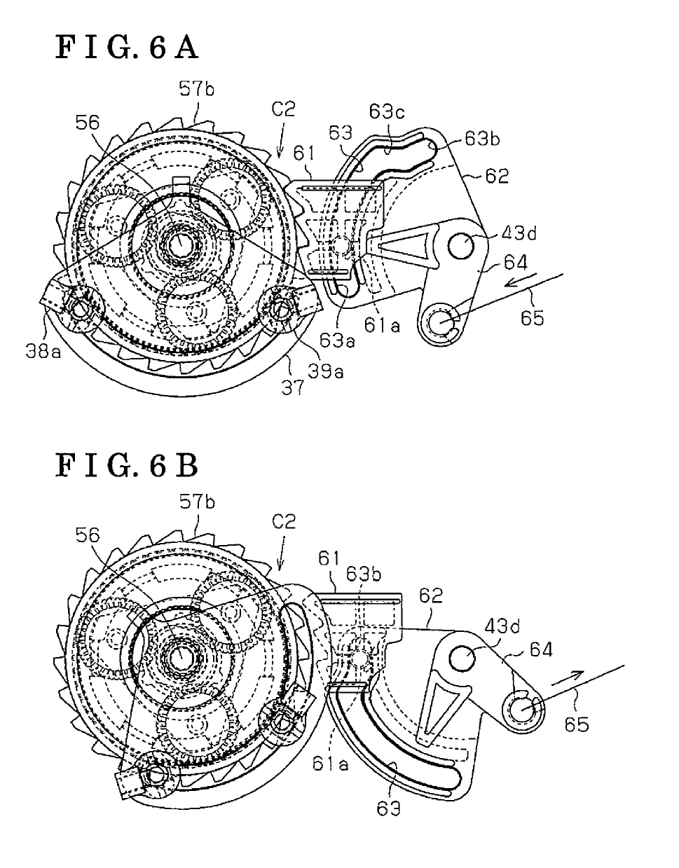

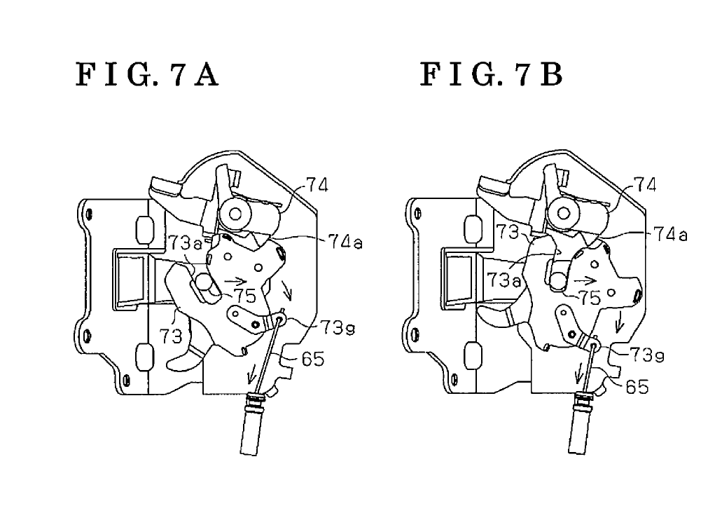

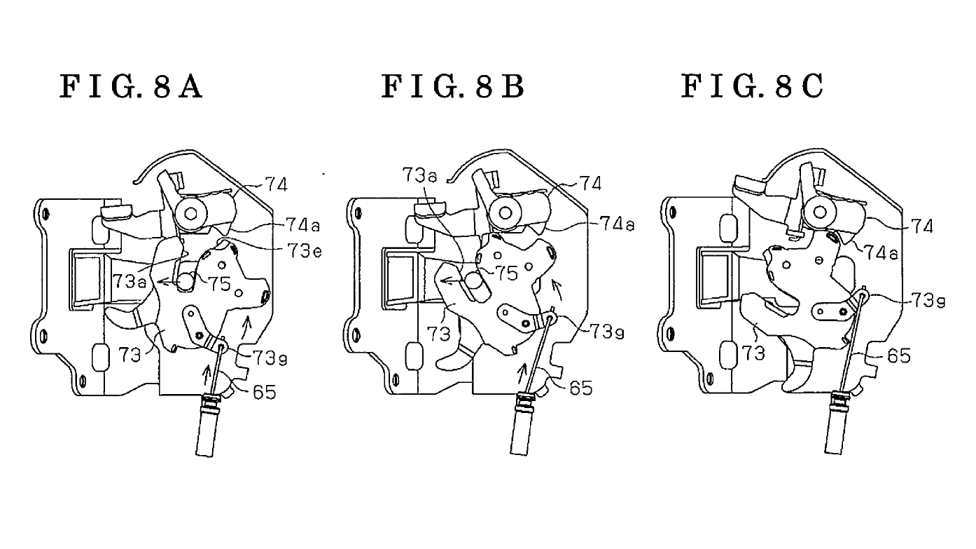

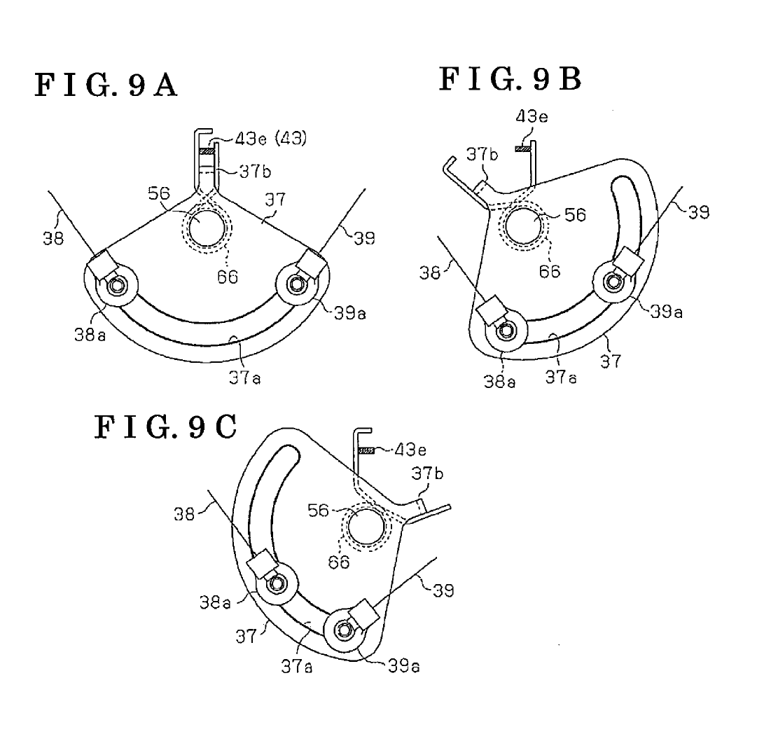

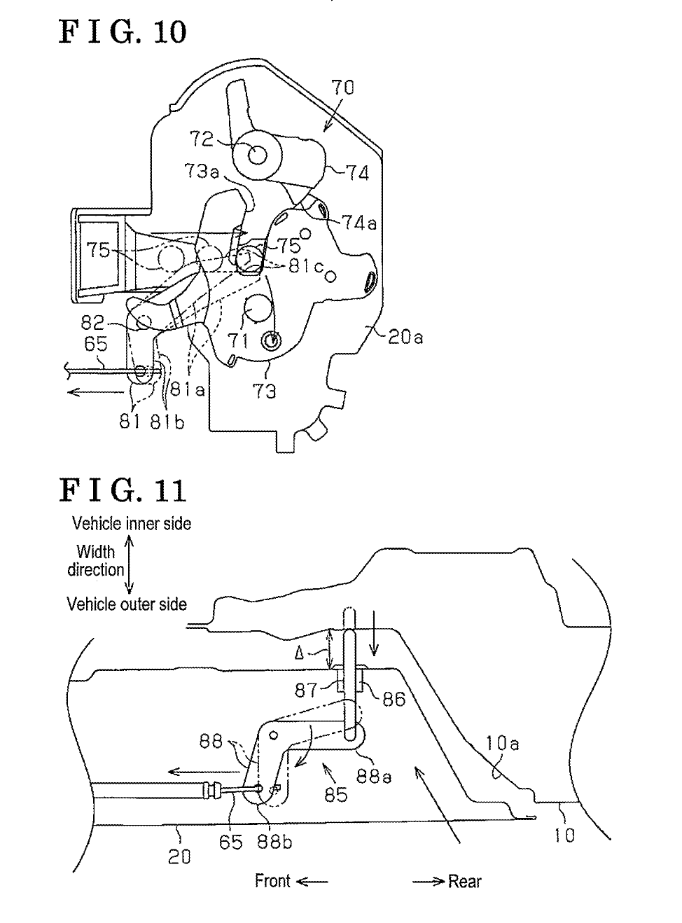

### BRIEF DESCRIPTION OF DRAWINGS

[FIG. 1] is a side view schematically illustrating a door opening and closing apparatus for a vehicle according to an embodiment of the present invention;

[FIG. 2] is a side view schematically illustrating the door opening and closing apparatus for the vehicle;

[FIG. 3A], [FIG. 3B] and [FIG. 3[] are explanatory views each of which illustrates an operation of a latch mechanism;

[FIG. 4] is an exploded perspective view of the latch mechanism;

[FIG. 5] is a longitudinal section view of the latch mechanism;

[FIG. 6A] and [FIG. 6B] are explanatory views each of which illustrates an operation of a second clutch;

[FIG. 7A] and FIG. 7B] are explanatory views each of which illustrates an operation of the latch mechanism;

[FIG. 8A], [FIG. 8B] and [FIG. 8C] are explanatory views each of which illustrates an operation of the latch mechanism;

[FIG. 9A], [FIG. 9B] and [FIG. 9C] are explanatory views each of which states an operation of an output lever;

[FIG. 10] is an elevation view illustrating a door opening and closing apparatus for a vehicle according to another example; and

[FIG. 11] is an elevation view illustrating a door opening and closing apparatus for a vehicle according to still another example.

### MODE FOR CARRYING OUT THE INVENTION

An embodiment of a door opening and closing apparatus for a vehicle of the present invention is explained with reference to FIGS. 1 to 9C. A front-rear direction of a vehicle corresponds to a “front-rear direction”. As illustrated in FIG. 1, a door opening 10a is provided at a side portion of a vehicle body 10. An upper rail 11 is arranged at the vehicle body 10 so as to extend along an upper edge of the door opening 10a. A lower rail 12 is arranged at the vehicle body 10 so as to extend along a lower edge of the door opening 10a. A center rail 13 is arranged at a quarter panel 10b positioned at a rear side of the door opening 10a so as to extend in the front-rear direction. A slide door 20 serving as a vehicle door is supported so as to be movable in the front-rear direction relative to the upper rail 11, the lower rail 12 and the center rail 13 via respective guide roller units 14. In a case where the slide door 20 moves in the front-rear direction, the door opening 10a is opened and closed. A cable guide 15 is provided at the quarter panel 10b so as to extend along a lower edge of the center rail 13. The cable guide 15 extends over a substantially entire length of the center rail 13.

A drive member 1 is fixed to a lower portion within the slide door 20. The drive member 21 includes a motor 22 and a drum 23 serving as a pulley which is rotated by motor 22. A first cable 24 and a second cable 25 each of which serves as a rope member are wound at the drum 23. Respective ends of the first and second cables 24 and 25 are connected to the drum 23 in a state being wound at the drum 23. The first and second cables 24 and 25 are selectively reeled in and out by the drive member 21.

The guide roller unit 14 is movably mounted at the center rail 13. A guide pulley 27 is connected to the guide roller unit 14. Each of the first and second cables 24 and 25 extends from the slide door 20 to the vehicle body 10 through an intermediate pulley 26 and the guide pulley 27 so as to be arranged along the cable guide 15 in the front-rear direction. The first cable 24 is guided by the cable guide 15 to be arranged forward. A tensioner 28 is connected to an end of the first cable 24. The first cable 24 is connected to the vehicle body 10 in the vicinity of a front end of the cable guide 15 via the tensioner 28. The second cable 25 is guided by the cable guide 15 to be arranged rearward. A tensioner 29 is connected to an end of the second cable 25. The second cable 25 is connected to the vehicle body 10 in the vicinity of a rear end of the cable guide 15 via the tensioner 29.

According to the aforementioned construction, in a case where the first cable 24 is reeled out and the second cable 25 is reeled in by the drive member 21, the slide door 20 moves rearward to open the door opening 10a. On the other hand, in a case where the first cable 24 is reeled in and the second cable 25 is reeled out by the drive member 21, the slide door 20 moves forward to close the door opening 10a.

As illustrated in FIG. 2, a remote controller 30 is mounted within the slide door 20. The remote controller 30 includes a mechanical portion 31 which is known to be constituted by plural levers. A front lock 32 serving as a door lock is mounted at a front portion of the slide door 20. A rear lock 33 serving as the door lock is mounted at a rear portion of the slide door 20. A fully open lock 34 serving as the door lock is mounted at a lower portion of the slide door 20.

Each of the front lock 32 and the rear lock 33 holds the slide door 20 to be in a closed state, i.e., in a fully closed state or in a half closed state, by engaging with the vehicle body 10 or brings the slide door 20 to an opening allowable state from the closed state by disengaging from the vehicle body 10. The fully open lock 34 holds the slide door 20 to be in a Fully open state by engaging with the vehicle body 10 or brings the slide door 20 to a closing allowable state from an open state by disengaging from the vehicle body 10.

As illustrated in FIG. 3A to FIG. 3C, a base plate 20a is fixed to the slide door 20. The rear lock 33 includes a latch mechanism 70 which is supported at the base plate 20a. A pair of rotation shafts 71 and 72 in parallel with each other is arranged at the base plate 20a. A latch 73 is rotatably mounted to the rotation shaft 71. A pawl 74 is rotatably mounted to the rotation shaft 72.

The latch 73 includes an engagement recess portion 73a in a substantially U-shape form. The latch 73 includes a first protruding portion 73b at a right side of the engagement recess portion 73a and includes a second protruding portion 73c at a left side of the engagement recess portion 73a. The latch 73 includes a third protruding portion 73d protruding from the first protruding portion 73b. A tip end surface of the first protruding portion 73b forms a fully latched engagement surface 73e. An end surface of the third protruding portion 73d facing the second protruding portion 73c forms a half latched engagement surface 73f. The latch 73 is biased by a latch biasing spring not illustrated in a counterclockwise rotation direction to be held at an unlatched position as illustrated in FIG. 3A. The latch 73 includes an interlocking piece 73g in an arm form extending from the rotation shaft 71 to a side opposite from the engagement recess portion 73a.

The pawl 74 includes an engagement end portion 74a in a substantially claw form. The engagement end portion 74a protrudes downward from a position radially away from the rotation shaft 72. The pawl 74 is biased in a clockwise rotation direction by a pawl biasing spring not illustrated, i.e., in a direction where the engagement end portion 74a moves downward, so as to be held at a predetermined rotation position illustrated in FIG. 3A.

Next, a basic operation of the latch mechanism 70 is explained. As illustrated in FIG. 3A, in a state where the slide door 20 is open, the engagement recess portion 73a of the latch 73 held at the unlatched position is arranged facing a striker 75 which is fixed to the vehicle body 10. That is, the engagement recess portion 73a opens an entry path of the striker 75 for the closing operation of the slide door 20. The engagement end portion 74a of the pawl 74 held at the predetermined rotation position is disposed at an upper side of the third protruding portion 73d. The state of the latch mechanism 70 at this time corresponds to an unlatched state (release state).

As illustrated in FIG. 3A an FIG. 3B, in association with the closing operation of the slide door 20, the striker 75 enters into the engagement recess portion 73a. At this time, the striker 75 presses an inner wall surface of the engagement recess portion 73a to thereby rotate the latch 73 in the clockwise rotation direction against the latch biasing spring. The half latched engagement surface 73f engages with the engagement end portion 74a so that the rotation of the latch 73 is restricted. At this time, the striker 75 engages with the engagement recess portion 73a to bring the slide door 20 to the half closed state. The state of the latch mechanism 70 at this time corresponds to a half latched state and the rotation position of the latch mechanism 70 at this time corresponds to a half latched position.

Then, as illustrated in FIG. 3B and FIG. 3C, with the further closing operation of the slide door 20, the striker 75 further enters into the engagement recess portion 73f. At this time, the inner wall surface of the engagement recess portion 73a is pressed by the striker 75 to thereby further rotate the latch 73 in the clockwise rotation direction against the latch biasing spring. The fully latched engagement surface 73e engages with the engagement end portion 74a so that the rotation of the latch 73 is restricted. At this time, the striker 75 engages with the engagement recess portion 73a to bring the slide door 20 to the fully closed state. The state of the latch mechanism 70 at this time corresponds to a fully latched state (engagement state) and the rotation position of the latch 73 corresponds to a fully latched position.

In the half latched state or the fully latched state, in a case where the pawl 74 rotates in the counterclockwise rotation direction against the pawl biasing spring, the engagement of the engagement end portion 74a with the half latched engagement surface 73f or with the fully latched engagement surface 73e is released. At ibis time, because the slide door 20 starts opening by a repulsive force of a seal member, the striker 75 which is retracted from the engagement recess portion 73a presses the inner wall surface of the engagement recess portion 73a, thereby rotating the latch 73 in the counterclockwise rotation direction. Then, the engagement between the engagement recess portion 73a and the striker 75 is released so that the slide door 20 may open.

The front lock 32 includes the latch mechanism 70 similar to that of the rear lock 33 except that the interlocking piece 73g of the latch 73 is omitted and operates in the similar way to the rear lock 33. The fully open lock 34 includes the latch mechanism 70 similar to that of the rear lock 33 and operates in the similar way to the rear lock 33 under a condition that “opening” and “closing” in the rear lock 33 are replaced with “closing” and “opening” in the fully open lock 34. Specifically, in a case where the latch mechanism 70 of the fully open lock 34 is in the half latched state, the slide door is brought to an open-side half closed state corresponding to the half closed state.

The pawl 74 of each of the front lock 32 and the rear lock 33 is mechanically connected to the mechanical portion 31 of the remote controller 30. In a case where a release operation force is input from the mechanical portion 31, the slide door 20 is brought to the opening allowable state relative to the vehicle body 10. The pawl 74 of the fully open lock 34 is also mechanically connected to the mechanical portion 31 of the remote controller 30. In a case where the release operation force is input from the mechanical portion 31, the slide door 20 is brought to the closing allowable state relative to the vehicle body 10. The release operation force corresponds to an operation force for rotating the pawl 74 against the pawl biasing spring so as to release the holding of the slide door 20 by the latch mechanism 70.

As illustrated in FIG. 2, an inside handle 35 is provided at an inner side of the remote controller 30. The inside handle 35 is mechanically connected to the mechanical portion 31 of the remote controller 30 so that the release operation force is input to each of the front lock 32, the rear lock 33 and the fully open lock 34 via the mechanical portion 31.

In the closed state of the slide door 20, a passenger may operate the inside handle 35 to a rear side from a neutral position (hereinafter referred to as an “opening direction”). In this case, the release operation force is input to each of the front lock 32 and the rear lock 33 via the mechanical portion 31 by the inside handle 35. As a result, each of the front lock 32 and the rear lock 33 brings the slide door 20 to the opening allowable state relative to the vehicle body 10.

On the other hand, in the fully open state of the slide door 20, the passenger may operate the inside handle 35 to a front side from the neutral position (hereinafter referred to as a “closing direction”). In this case, the release operation force is input to the fully open lock 34 via the mechanical portion 31 by the inside handle 35. Accordingly, the fully open lock 34 brings the slide door 20 to the closing allowable state relative to the vehicle body 10.

An outside handle 36 is provided at an outer side of the slide door 20. The outside handle 36 is mechanically connected to the mechanical portion 31 of the remote controller 30 so that the release operation force is input to each of the front lock 32, the rear lock 33 and the fully open lock 34 via the mechanical portion 31.

An output lever 37 serving as an output member which is driven to rotate by motor 22 is provided at a lower portion within the slide door 20. The output lever 37 is arranged coaxially with the drum 23. The output lever 37 is mechanically connected to the mechanical portion 31 of the remote controller 30 via a release cable 38. The output lever 37 is also mechanically connected to the latch 73 of the rear lock 33 via a closer cable 39.

The output lever 37 rotates in one direction so that the release operation force is input to each of the front lock 32, the rear lock 33 and the fully open lock 34 via the release cable 38 and the mechanical portion 31. As a result, the slide door 20 is bought to the opening allowable state from the closed state or to the closing allowable state from the fully open state.

In addition, the output lever 37 rotates in the other direction so that an engagement operation force is input to the rear lock 33 via the closer cable 39. The engagement operation three corresponds to an operation force for rotating the latch 73 of the rear lock 33 from the half latched position to the fully latched position against the latch biasing spring. As a result, the rear lock 33 is switched, together with the front lock 32, from a state holding the slide door 20 in the half closed state to a state holding the slide door 20 in the fully closed state.

Next, the construction of the drive member 21 is further explained. As illustrated in FIGS. 4 and 5, the drive member 21 includes a motor housing 41, a drum cover 42 and a locking housing 43. The motor housing 41 made of resin houses a worm 44 which is provided at a rotation shaft of the motor 22 in a rotatable manner. The motor housing 41 also houses a worm wheel portion 45a of a worm wheel 45 in a rotatable manner, the worm wheel 45 being made of resin material. The worm wheel portion 45a serves as a transmission gear meshed with the worm 44. The worm wheel portion 45a is formed in a substantially cylindrical configuration including a lid and opening downward. A gear-side accommodation void Sg is provided within the worm wheel portion 45a. The worm wheel 45 integrally includes a first sun gear portion 45b and a second sun gear portion 45c. The first sun gear portion 45b protrudes upward to be coaxial with the worm wheel portion 45a from a lid wall portion of the worm wheel portion 45a. The second sun gear portion 45c protrudes downward to be coaxial with the worm wheel portion 45a from the lid wall portion of the worm wheel portion 45a. The second sun gear portion 45c is formed in a size so as to be housed within the gear-side accommodation void Sg.

The drum cover 42 made of resin is formed in a substantially cylindrical configuration including a lid and opening downward. The drum cover 42 houses the drum 23 so that the drum 23 is rotatable in a state where the drum cover 42 is fixed to an upper side surface of the motor housing 41. The drum 23 is fixed to a first support shaft 46 which is coaxially arranged with the worm wheel 45 to rotate together with the first support shall 46. One end of the first support shaft 46 is supported at the first sun gear portion 45b and the other end of the first support shaft 46 is supported at a bearing 47. The bearing 47 is mounted to a lid wall portion of the drum cover 42. According to the aforementioned construction, the drum 23 is rotatable within the drum cover 42.

The drum 23 is formed in a substantially cylindrical configuration including a lid and opening downward. A drum-side accommodation void Sd is provided within the drum 23. A first ring gear 48 and a first carrier 49 are housed in the drum-side accommodation void Sd. The first sun gear portion 45b, the first ring gear 48 and the first carrier 49 constitute a first clutch C1 serving as an opening and closing clutch.

The first ring gear 48 is formed in a substantially cylindrical configuration including a lid and opening downward. A first internal gear 48a is provided at an inner peripheral portion of the first ring gear 48. The first ring gear 48 includes a large gear 48b in an annular form covering an opening end of the drum 23. The large gear 48b protrudes outwardly along a radial direction from a tip end portion of the first ring gear 48 projecting from the drum-side accommodation void Sd. The first internal gear 48a constitutes, together with the first sun gear portion 45b and the first carrier 49, a planetary gear mechanism.

The first carrier 49 includes a first holding plate 49a fixed to the first support shaft 46 to rotate therewith and including a substantially Y-shaped plate form, three of first planetary gears 49b and a first carrier plate 49c in a substantially annular form. The first planetary gears 49b are respectively rotatably supported at three branched end portions of the first holding plate 49a. Three of the first planetary gears 49b are held between the first carrier plate 49c and the first holding plate 49a an as not to disengage in an axial direction. In a state where the first carrier 49 is inserted to be positioned within the first ring gear 48, three of the first planetary gears 49b are meshed with the first internal gear 48a. In addition, in a state where the first sun gear portion 45b is inserted to be positioned within the first carrier 49, three of the first planetary gears 49b are meshed with the first sun gear portion 45b.

The drum cover 42 houses, together with the drum 23, the first clutch C1. The drum cover 42 includes a guide bore 42a which opens in the radial direction along an axis of the large gear 48b. A guide block 50 is fixed to the drum cover 42 or the motor housing 41. The guide block 50 is arranged facing the guide bore 42a. The guide block 50 includes a first guide groove 50a opening in the radial direction of the drum cover 42. The first guide groove 50a is positioned facing the guide bore 42a. A first internal gear fixing block 51 is movably mounted to the first guide groove 50a.

In a case of approaching the first ring gear 48, the first internal gear fixing block 51 engages with the large gear 48b so that the first ring gear 48 becomes non-rotatable. At this time, the first sun gear portion 45b, the first internal gear 48a and the first carrier 49 function as an input shaft, a fixed shaft and an output shaft of the planetary gear mechanism. As a result, the rotation of the first sun gear portion 45b (worm wheel 45) is transmittable to the first carrier 49. The aforementioned state corresponds to a connection state of the first clutch C1.

On the other hand in a case of separating from the first ring gear 48, the first internal gear fixing block 51 disengages from the large gear 48b so that the first ring gear 48 becomes rotatable. At this time, the rotation of the first sun gear portion 45b (worm wheel 45) is not transmittable to the first carrier 49. The aforementioned state corresponds to a disconnection state of the first clutch C1.

The first internal gear fixing block 1 includes an engagement pin 51a protruding at an upper side than the guide block 50. A first switching lever 53 in a substantially fan plate form is rotatably connected at an upper side surface of the guide block 50 via a pin 52. A cam bore 53a as an elongated bore is provided at a tip end of the first switching lever 53 so that the engagement pin 51a is inserted to be positioned within the cam bore 53a. In a case where the first switching lever 53 rotates about the pin 52 in one direction, the engagement pin 51a is pushed out by means of the cam bore 53a so that the first internal gear fixing block 51 comes closer to the first ring gear 48. On the other hand, in a case where the first switching lever 53 rotates about the pin 52 in the other direction, the engagement pin 51a is pulled in by means of the cam bore 53a so that the first internal gear fixing block 1 separates from the first ring gear 48.

The first switching lever 53 is connected to a switching actuator 54 including an electric motor via a rod 55. The first switching lever 53 is selectively driven to rotate in one direction and the other direction by the switching actuator 54. Timing which the switching actuator 54 drives the first switching lever 53, i.e., switching timing of the first clutch C1, is electrically controlled on a basis of an opening and closing position of the slide door 20 detected by a door position sensor.

The locking housing 43 made of resin includes an accommodation portion 43a formed in a substantially cylindrical configuration including a lid and opening upward. The locking housing 43 supports the worm wheel 45 so that the worm wheel 45 is rotatable. A second support shaft 56 which is coaxially arranged with the worm wheel 45 is supported at the accommodation portion 43a. One end of the second support shaft 56 is inserted and pivotally supported at a bearing bore 43b including a substantially circular configuration and provided at a bottom portion of the accommodation portion 43a. The other end of the second support shaft 56 is pivotally supported at the second sun gear portion 45c. Accordingly, the second sun gear portion 45c (worm wheel 45) is rotatably supported at the locking housing 43 via the second support shaft 56.

A second ring gear 57 and a second carrier 58 are housed in the gear-side accommodation void Sg. The second sun gear portion 45c, the second ring gear 57 and the second carrier 58 constitute a second clutch C2 serving as a locking clutch.

The second ring gear 57 is formed in a substantially cylindrical configuration including a lid and opening upward. A second internal gear 57a is provided at an inner peripheral portion of the second ring gear 57. The second ring gear 57 includes a large gear 57b in an annular form. The large gear 57b protrudes outwardly along the radial direction from a tip end of the ring gear 57 projecting from the gear-side accommodation void Sg. The second ring gear 57 constitutes, together with the second sun gear portion 45c and the second carrier 58, a planetary gear mechanism.

The second carrier 58 includes a second holding plate 58a in a substantially triangular plate form fixed to the second support shaft 56 to rotate therewith, three of second planetary gears 58b and a second carrier plate 58c in a substantially triangular annular form. The second planetary gears 58b are respectively rotatably supported at three corner portions of the second holding plate 58a. Three of the second planetary gears 58b are held between the second carrier plate 58c and the second holding plate 58a so as not to disengage in the axial direction. In a state where the second carrier 58 is inserted to be positioned within the second ring gear 57, three of the second planetary gears 58b are meshed with the second internal gear 57a. in addition, in a state where the second sun gear portion 45c is inserted to be positioned within the second carrier 58, three of the second planetary gears 58b are meshed with the second sun gear portion 45c.

A second guide groove 43c is provided at the locking housing 43. The second guide groove 43c extends in the radial direction of the accommodation portion 43a an as to be continuously formed within the accommodation portion 43a. A second internal gear fixing block 61 is movably mounted to the second guide groove 43c at a position corresponding to the large gear 57b.

As illustrated in FIG. 6A, in a case of approaching the second ring gear 57, the second internal gear fixing block 61 engages with the large gear 57b so that the second ring gear 57 becomes non-rotatable. At this time, the second sun gear portion 45c, the second internal gear 57a and the second carrier 58 fit Hi as an input shaft, a fixed shaft and an output shaft of the planetary gear mechanism. As a result, the rotation of the second sun gear portion 45c (worm wheel 45) is transmittable to the second carrier 58. The aforementioned state corresponds to a connection state of the second clutch C2.

On the other hand, as illustrated in FIG. 6B, in a case of separating from the second ring gear 57, the second internal gear fixing block 61 disengages from the large gear 57b so that the second ring gear 57 becomes rotatable. At this time, the rotation of the second sun gear portion 45c (worm wheel 45) is not transmittable to the second carrier 58. The aforementioned state corresponds to a disconnection state of the second clutch C2.

The second internal gear fixing block 61 includes an engagement pin 61a protruding upward. The locking housing 43 includes a shaft portion 43d in a pin form protruding upward at an opposite side from the accommodation portion 43a relative to the second guide groove 43c. A second switching lever 62 in a substantially fan plate form is rotatably connected to the shaft portion 43d. A cam bore 63 as an elongated bore is provided at an end portion of the second switching lever 62 so that the engagement pin 61a is inserted to the cam bore 63.

As illustrated in FIG. 6A and FIG. 6B, the cam bore 63 includes a large diameter groove 63a in an arc form with reference to the shaft portion 43d. In addition, the cam bore 63 includes a small diameter groove 63b in an arc form with reference to the shaft portion 43d at a portion closer to the shaft portion 43d than the large diameter groove 63a at a right side of the cam bore 63. The large diameter groove 63a and the small diameter groove 63b are connected to each other via a guide groove 63c which is inclined. A circumferential length of the large diameter groove 63a is greater than a circumferential length of the small diameter groove 63b.

Accordingly, in a case where the second switching lever 62 rotates about the shaft portion 43d in the clockwise rotation direction, the engagement pin 61a is pushed out by means of the large diameter groove 63a so that the second internal gear fixing block 61 comes closer to the second ring gear 57. On the other hand, in a case where the second switching lever 62 rotates about the shaft portion 43d in the counterclockwise rotation direction, the engagement pin 61a is pulled in by means of the small diameter groove 63b so that the second internal gear fixing block 61 separates from the second ring gear 57.

The second switching lever 62 includes an arm portion 64. The arm portion 64 protrudes in the radial direction with reference to the shaft portion 43d. One end of a door position interlocking cable 65 constituted by a push-pull cable is connected to the arm portion 64. The other end of the door position interlocking cable 65 is connected to the interlocking piece 73g of the rear lock 33. The arm portion 64 receives an engagement and disengagement operation force depending on an opening and closing state of the slide door 20 via the door position interlocking cable 65. The interlocking piece 73g, the door position interlocking cable 65 and the arm portion 64 constitutes an interlocking mechanism.

That is, as illustrated in FIG. 7A, in a case where the slide door 20 starts closing from the open state so that the striker 75 enters into the engagement recess portion 73a of the latch 73 of the rear lock 33, the striker 75 pushes the inner wall surface of the engagement recess portion 73a. Accordingly, the latch 73 starts rotating from the unlatched position to the fully latched position. Then, the latch 73 pushes the door position interlocking cable 65 via the interlocking piece 73g. At this time, as illustrated in FIG. 6B, the arm portion 64 is pressed by the door position interlocking cable 65 to thereby rotate the second switching lever 62 in the clockwise rotation direction. Therefore, the second clutch C2 is brought to the connection state.

After the second clutch C2 is brought to the connection state, the farther rotation of the latch 73 causes the second switching lever 62 to be pressed to keep rotating by the door position interlocking cable 65. At this time, the engagement pin 61a of the second internal gear fixing block 61 moves within the large diameter groove 63a so as to maintain the connection state of the second clutch C2 (second clutch-side lost motion).

On the other hand, FIG. 8A illustrates a state where the engagement of the engagement end portion 74a of the pawl 74 with the fully latched engagement surface 73e of the latch 73 is released in the fully closed state of the slide door 20. In this case, the inner wall surface of the engagement recess portion 73a is pressed by the striker 75 that is retracting from the engagement recess portion 73a. Thus, the latch 73 starts rotating to the unlatched position from the fully latched position. Then, the latch 73 of the rear lock 33 pulls the door position interlocking cable 65 via the interlocking piece 73g. At this time, as illustrated in FIG. 6A and FIG. 6B, the arm portion 64 is pulled by the door position interlocking cable 65 and thus the second switching lever 62 rotates in the counterclockwise rotation direction. As a result, the second clutch C2 is brought to the disconnection state. At this time, the second clutch C2 is brought to the disconnection state after the engagement pin 61a of the second internal gear fixing block 61 completes moving the lame diameter groove 63a.

In the similar manner, the interlock piece 73g of the latch 73 is connected to second switching lever 62 in the fully open lock 34. The second clutch C2 in the fully open lock 34 is operated in the similar manner to the rear lock 33 under a condition that “opening” and “closing” in the rear lock 33 are replaced with “closing” and “opening” in the fully open lock 34.

As illustrated in FIGS. 4, 5, 9A to 9C, a tip end of the second support shaft 56 penetrates through the accommodation portion 43a to be connected to the output lever 37. The output lever 37 rotates together with the second support shaft 56. A slit 37a as an elongated bore is provided at an end portion of the output lever 37. The slit 37a extends in an arc with reference to the second support shaft 56. An end 38a of the release cable 38 and an end 39a of the closer cable 39 are inserted to the slit 37a and held thereat so as not to disengage from the slit 37a.

A movable-side engagement piece 37b in a substantially square plate form is provided at a base end of the output lever 37. The movable-side engagement piece 37b is bent in a direction orthogonal to a paper surface on which FIGS. 9A to 9C are drawn. The locking housing 43 includes a fixed-side engagement piece 43e in a substantially square plate form configured to face the movable-side engagement piece 37b. The fixed-side engagement piece 43e is away from the second support shaft 56 than the movable-side engagement piece 37b.

A return spring 66 constituted by a torsion coil spring is wound at the second support shaft 56. Respective ends of the return spring 66 extend from the second support shaft 56 to the fixed-side engagement piece 43e along the radial direction. The respective ends of the return spring 66 are elastically contactable to respective ends of the fixed-side engagement piece 43e.

As illustrated in FIG. 9A, the return spring 66 biases and holds the output lever 37 in a state where the fixed-side engagement piece 43e and the movable-side engagement piece 37b are arranged side by side in the radial direction. The rotation position of the output lever 37 at this time corresponds to an initial position Ps.

In a state where the output lever 37 is held at the initial position Ps, the end 38a of the release cable 38 and the end 39a of the closer cable 39 are arranged at respective circumferential ends of the slit 37a. In the aforementioned state, as illustrated in FIG. 9B, in a case where the output lever 37 rotates in the counterclockwise rotation direction (which may be hereinafter also referred to as a “release direction”) against a biasing force of the return spring 66, the end 38a is pressed by the slit 37a so that the release cable 38 is pulled. At this time, the release operation force is input to each of the front lock 32, the rear lock 33 and the fully open lock 34 via the mechanical portion 31. Because the end 39a moves within the slit 37a, the closer cable 39 is inhibited from being pulled (closer-side lost motion).

On the other hand, as illustrated in FIG. 9C, in a case where the output lever 37 rotates from the initial position Ps in the clockwise rotation direction (which may be hereinafter also referred to as a “closer direction”) against the biasing force of the return spring 66, the end 39a is pressed by the slit 37a so that the closer cable 39 is pulled. At this time, the engagement operation force is input to the latch 73 of the rear lock 33. Because the end 38a moves within the slit 37a, the release cable 38 is inhibited from being pulled (release-side lost motion).

Next, an operation of the present embodiment is explained. In a case where the slide door 20 is in the open state, the latch 73 of the rear lock 33 is arranged at the unlatched position and the engagement pin 61a of the second internal gear fixing block 61 is arranged at the small diameter groove 63b of the second switching lever 62. Thus, the second clutch C2 is in the disconnection state.

In the aforementioned state, the first clutch C1 is switched to the connection state by the switching actuator 54 and the motor 22 is rotated for closing the slide door 20. Then, the rotation of the worm 44 is transmitted to the drum 23 via the worm wheel portion 45a and the first clutch C1 to thereby start closing operation of the slide door 20.

In a case where the striker 75 enters into the engagement recess portion 73a of the latch 73 with the closing operation of the slide door 20 as illustrated in FIG. 7A, the inner wall surface of the engagement recess portion 73a is pressed by the striker 75 an that the latch 73 starts rotating from the unlatched position. In addition, the door position interlocking cable 65 is pressed by the interlocking piece 73g of the latch 73 of the rear lock 33, which starts rotating the second switching lever 62. In a case where the latch 73 rotates close to the half latched position, the large diameter groove 63a of the second switching lever 62 reaches the engagement pin 61a of the second internal gear fixing block 61. The second clutch C2 is switched to the connection state accordingly.

Next, the first clutch C1 is switched to the disconnection state by the switching actuator 54 and the motor 22 is continuously rotated. Then, the rotation of the worm 44 is transmitted to the output lever 37 via the worn wheel portion 45a and the second clutch C2. Accordingly, the output lever 37 rotates in the closer direction from the initial position Ps. The closer cable 39 is pulled so that the engagement operation force is input to the latch 73 of the rear lock 33.

In association with the above, as illustrated in FIG. 7B, the latch 73 of the rear lock 33 rotates to the fully latched position while pulling in the striker 75 and the engagement end portion 74a of the pawl 74 engages with the fully latched engagement surface 73e. Accordingly, the latch mechanism 70 is brought to the fully latched state. The slide door 20 is held in the fully closed state. In the fully latched state of the latch mechanism 70, the latch 73 maintains the fully latched position. Thus, even when the motor 22 is stopped, the second clutch C2 maintains the connection state. In addition, when the motor 22 is stopped, the output lever 37 is biased by the return spring 66 so as to return to the initial position Ps. The latch mechanism 70 of the front lock 32 is brought to the fully latched state so as to conform to closing operation of the slide door 20 by the rear lock 33.

While the latch 73 is rotating to the fully latched position, specifically, to an over-latched position beyond the fully latched position, the second switching lever 62 is continuously pressed by the door position interlocking cable 65. At this time, the second clutch-side lost motion is performed by the large diameter groove 63a as mentioned above. In a case where the engagement operation force is input to the latch 73 of the rear lock 33, the release-side lost motion is performed by the slit 37a so that the release operation force is inhibited from being input to each of the front lock 32, the rear lock 33 and the fully open lock 34.

As mentioned above, during the closing operation of the slide door 20, the switching of the second clutch C2 from the disconnection state to the connection state is performed at a time when the latch 73 rotates close to the half latched position, i.e., the slide door 20 reaches a slightly open side relative to the half closed state. This is because, if the switching is performed at a time when the latch 73 reaches a closed side relative to the half closed state, the output lever 37 is still non-rotatable when the slide door 20 is stopped and held in the half closed state. Thus, the release operation by each of the front lock 32 and the rear lock 33 is not obtainable, which inhibits the opening operation of the slide door 20.

A case where the slide door 20 is in the fully closed state is explained. At this time, as mentioned above, the second clutch C2 is in the connection state. In the aforementioned state, the motor 22 is rotated so that the release operation force is input to each of the front lock 32, the rear lock 33 and the fully open lock 34 with the first clutch C1 being disconnected. Then, the rotation of the worm 44 is transmitted to the output lever 37 via the worm wheel portion 45a and the second clutch C2. Accordingly, the output lever 37 rotates in the release direction from the initial position Ps to pull the release cable 38. The release operation force is input to each of the front lock 32, the rear lock 33 and the fully open lock 34 via the mechanical portion 31.

In association with the above, in a case where the engagement between the engagement end portion 74a of the pawl 74 and the fully latched engagement surface 73e is released as illustrated in FIG. 8A, the striker 75 which is retracting from the engagement recess portion 73a pushes the inner wall surface of the engagement recess portion 73a. Thus, the latch 73 starts rotating from the fully latched position to the unlatched position. In addition, the door position interlocking cable 65 is pulled by the interlocking piece 73g of the latch 73 of the rear lock 33 so that the second switching lever 62 starts rotating. As illustrated in FIG. 8B, in a case where the latch 73 rotates slightly beyond the half latched position, the small diameter groove 63b of the second switching lever 62 reaches the engagement pin 61a of the second internal gear fixing block 61. The second clutch C2 is switched to the disconnection state accordingly. In a case where the second clutch C2 is switched to the disconnection state, the output lever is biased by the return spring 66 so as to return to the initial position Ps. The second switching lever 62 keeps rotating until the latch 73 of the rear lock 33 reaches the unlatched position as illustrated in FIG. 8C. At this time, the second clutch-side lost motion is performed by the large diameter groove 63a.

As mentioned above, during the opening operation of the slide door 20, the switching of the second clutch C2 from the connection state to the disconnection state is performed at a time when the latch 73 rotates slightly beyond the half latched position, i.e., the slide door 20 reaches a slightly open side relative to the half closed state. This is because, if the switching is performed at a time when the latch 73 reaches the closed side relative to the half closed state, the output lever 37 is already non-rotatable when the slide door 20 is stopped and held in the half closed state. Thus, the release operation by each of the front lock 32 and the rear lock 33 is not obtainable, which inhibits the opening operation of the slide door 20.

Next, in a case where the first clutch C1 is switched to the connection state by the switching actuator 54 and the motor 22 is continuously rotated, the rotation of the worm 44 is transmitted to the drum 23 via the worm wheel portion 45a and the first clutch C1. The opening operation of the slide door 20 is then started. In association with the opening operation of the slide door 20, the latch 73 of the fully open lock 34 is brought to the fully latched state while pulling in the striker 75, thereby holding the slide door 20 in the fully open state.

As mentioned above, in the fully open lock 34, the second clutch C2 is operated in the same way as the rear lock 33. Thus, during the opening operation of the slide door 20, the switching of the second clutch C2 from the disconnection state to the connection state is performed at a time when the latch 73 rotates close to the half latched position, i.e., the slide door 20 reaches a slightly closed side relative to the open-side half closed state. This is because, if the switching is performed at a time when the latch 73 reaches the open side relative to the open-side half closed state, the output lever 37 is still non-rotatable when the slide door 20 is stopped and held in the open-side half closed state. Thus, the release operation by the fully open lock 34 is not obtainable, which inhibits the closing operation of the slide door 20.

In the connection state of the second clutch C2, the first clutch C1 is switched to the disconnection state. In this case, the motor 22 may rotate in an opposite direction so that the fully open lock 34 performs the closer operation to bring the slide door 20 to the fully open state. The slide door 20 may be brought to the fully open state with an inertia motion of the slide door 20.

In the closing operation of the slide door 20 in the fully open state, the motor 22 is rotated on that the release operation force is input to each of the front lock 32, the rear lock 33 and the fully open lock 34. In addition, the second clutch C2 is switched to the disconnection state and the first clutch C1 is switched to the connection state. In a case where the motor 22 is rotated in the opposite direction from the aforementioned state, the rotation of the worm 44 is transmitted to the drum 23 via the worm wheel portion 45a and the first clutch C1 to thereby start the closing operation of the slide door 20. The shifting of the slide door 20 to the fully closed state with the closing operation of the slide door 20 is as mentioned above.

Specifically, the switching of the second clutch C2 from the connection state to the disconnection state for bringing the slide door 20 to close from the fully open state is performed at the time the slide door 20 reaches the slightly closed side relative to the open-side half closed state. This is because, if the switching is performed at the time when the slide door 20 reaches the open side relative to the open-side half closed state, the output lever 37 is already non-rotatable when the slide door 20 is stopped and held in the open-side half closed state. Thus, the release operation by the full open lock 34 is not obtainable, which inhibits the closing operation of the slide door 20.

According to the embodiment, the following effects are obtainable.

(1) The second clutch C2 that is a mechanical clutch is automatically switchable, by the interlocking piece 73g, to the connection state or the disconnection state of the rotation transmission between the motor 22 and the output lever 37 depending on the state of the slide door 20. Thus, as compared to a case where an electromagnetic clutch is provided, reduced weight and cost are achievable. The mechanical second clutch C2 is automatically switchable to the connection state or the disconnection state of the rotation transmission. Thus, an electric drive source for the switching is unnecessary, which is advantageous for the reduced weight and cost.

(2) Because of the second clutch-side lost motion, the interlocking piece 73g is inhibited from keeping operating relative to the second clutch C2 in the connection state of the rotation transmission by interlocking with the opening and closing operation of the slide door 20 between the fully closed state and the half closed state. As a result, the operation of the second clutch C2 is stabilized. In the same way, because of the second clutch-side lost motion, the interlocking piece 73g is inhibited from keeping acting on the second clutch C2 in the connection state of the rotation transmission by interlocking with the opening and closing operation of the slide door 20 between the fully open state and the open-side half closed state. Accordingly, the operation of the second clutch C2 is stabilized.

(3) The drum 23 related to the opening and closing operation of the slide door 20 may be operated by the motor 22 which is shared with the output lever 37 in a case he first clutch C1 is in the connection state of the rotation transmission between the motor 22 and the drum 23. Then, a transition from a state where the drum 23 is rotated for closing the slide door 20 to a state where the output lever 37 is rotated for operating the rear lock 33 so that the slide door 20 is brought to the fully closed state from the half closed state may be easily performed. Alternatively, a transition from a state where the output lever 37 is rotated for operating the rear lock 33 so that the slide door 20 is brought to the half closed state (opening allowable state) from the fully closed state to a state where the drum 23 is rotated for opening the slide door 20 may be easily performed.

(4) The interlocking piece 73g at the existing latch 73 is utilized for switching the second clutch C2 between the connection state and the disconnection state of the rotation transmission. Thus, a construction for switching the second clutch C2 may be simplified.

(5) An electrical element for switching the second clutch C2 to the connection state or the disconnection state of the rotation transmission is not necessary. Thus, reliability of the system improves.

(6) The output of the single motor 22 which is commonly used is switched by the first clutch C1 and the second clutch C2 so as to realize the opening and closing operation and the release and closer operation. Accordingly, as compared to a case where two motors are utilized to perform the opening and closing operation and the release and closer operation respectively, the number of components, weight and cost may be reduced. In addition, the mass of the slide door 20 is reduced, which may be beneficial for a pinching detection.

(7) In the open state of the slide door 20 excluding the fully open state, in a case where the motor 22 is rotated in one direction with the connection state of the first clutch C1 for achieving the closing operation, and thereafter the first clutch C1 and the second clutch C2 are switched to the disconnection state and the connection state respectively and the motor 22 is continuously rotated in one direction, the slide door 20 is brought to the fully closed state with the closer operation. In this case, without reversely rotating the motor 22, a transition from the closing operation to the closer operation of the slide door 20 is capable. Thus, a delay of an operation stud caused by a reverse rotation of the motor or a complex control may be restrained.

In addition, in the fully closed state of the slide door 20, in a case where the motor 22 is rotated in the other direction with the connection state of the second clutch C2 for achieving the release operation, and thereafter the first clutch C1 the second clutch C2 are switched to the connection state and the disconnection state respectively and the motor 22 is continuously rotated in the other direction, the slide door 20 is brought to the fully open state with the opening operation. In this case, without reversely rotating the motor 22, a transition from the release operation to the opening operation of the slide door 20 is capable. Thus, the delay of the operation start caused by the reverse rotation of the motor or the complex control may be restrained.

(8) Because the connection and disconnection of the first clutch C1 and the connection and disconnection of the second clutch C2 are independently switchable, the opening and closing operation and the release and closer operation may be independently performed. Thus, a contradictory operation where the first and second cables 24 and 25 are stretched during the release operation, the release cable 38 and the closer cable 39 are continuously pulled during the opening and closing operation, for example, may be restrained.

(9) In a case where the slide door 20 is manually opened and closed, as long as a state where the rotation of the first ring gear 48 is permitted by the first internal gear fixing block 51 is achieved, the rotation of the drum 23 (first carrier 49) is permitted while the first ring gear 48 is idly rotating. Accordingly, because a rotation torque from the drum 23 and a drive torque from the motor 22 are separated from each other by the first internal gear fixing block 51, the slide door 20 may be opened and closed with a small operation force.

(10) A state where the rotation of the first ring gear 48 is restricted and a state where the rotation of the first ring gear 48 is permitted are electrically switchable by the switching actuator 54. Thus, a burden caused by a manual operation may be eliminated.

(11) The state where the rotation of the first ring gear 48 is restricted and the state where the rotation of the first ring gear 48 is permitted are switchable by the switching actuator 54 with a small size including the small number of components. Thus, as compared to a construction where the electromagnetic clutch is utilized, the reduced cost and weight are achievable.

The aforementioned embodiment may be modified as follows. As illustrated in FIG. 10, an interlocking mechanism constituted by an interlocking lever 81 which is rotatably provided at the slide door 20 may be employed so as to conform to the arrangement of the latch mechanism 70 of the rear lock 33. The interlocking lever 81 is rotatably supported by a rotation shaft 82 which is in parallel with the rotation shaft 71. The interlocking lever 81 includes a pressed piece 81a and an interlocking piece 81b which extend along the radial direction relative to the rotation shaft 82. The interlocking lever 81 blocks a moving path of the striker 75 via the pressed piece 81a in an initial state where the interlocking lever 81 is released from an external force. In addition, the interlocking lever 81 opens the moving path of striker 75 by rotating in the clockwise rotation direction because the pressed piece 81a is pressed by the striker 75 with the approach of the striker 75.

Specifically, in a case where the striker 75 approaches by a predetermined distance, a tip end surface 81c of the pressed piece 81a that makes contact with the striker 75 matches the moving path of a lower edge of the striker 75 to thereby open the moving path of the striker 75. Once the aforementioned state is reached, the rotation of the interlocking lever 81 is kept stopping even the striker 75 further approaches. The predetermined distance by which the striker 75 approaches at the time the rotation of the interlocking lever 81 is stopped is specified so as to conform to the state where the latch 73 reaches close to the half latched position. That is, until the latch 73 reaches close to the half latched position from the unlatched posit n, the interlocking lever 81 keeps rotating and thereafter the rotation of the interlocking lever 81 is stopped.

The interlocking piece 81b of the interlocking lever 81 is connected to the end of the door position interlocking cable 65. Thus, the arm portion 64 of the second switching lever 62 receives the engagement and disengagement operation force via the door position interlocking cable 65 depending on the opening and closing position (opening and closing state) of the slide door 20. The interlocking lever 81, the door position interlocking cable 65 and the arm portion 64 constitute the interlocking mechanism.

At this time, in a case where the striker 75 approaches with the closing operation of the slide door 20 from the open state thereof the striker 75 presses the pressed piece 81a so that the interlocking lever 81 starts rotating. At the same time, the latch 73 starts rotating to the fully latched position from the unlatched position. At this time, the second switching lever 62 where the arm portion 64 is pressed by the door position interlocking cable 65 starts rotating. Then, in a case where the latch 73 rotates close to the half latched position, the second clutch C2 is brought to the connection state. At this stage, because the rotation of the interlocking lever 81 is stopped, the second switching lever 62 is inhibited from being continuously pressed by the door position interlocking cable 65 even when the striker 75 farther approaches The connection state of the second clutch C2 is maintained accordingly (second clutch-side lost motion).

On the other hand, in a case where the engagement between the engagement end portion 74a of the pawl 74 and the fully latched engagement surface 73e of the latch 73 is released, the inner wall surface of the engagement recess portion 73a is pressed by the striker 75 which is retracting from the engagement recess portion 73a. Therefore, the latch 73 starts rotating to the unlatched position from the fully latched position. At this stage, the rotation of the interlocking lever 81 is kept being stopped and the second clutch C2 is kept being in the connection state. Then, when the latch 73 moves beyond the half latched position, the interlocking lever 81 starts rotating to the initial state while the pressed piece 81a is being released from the striker 75. At this time, the arm portion 64 is pulled by the door position interlocking cable 65 and the second switching lever 62 starts rotating. As a result, the second clutch C2 is brought to the disconnection state.

The interlocking lever similar to the interlocking lever 81 is rotatably provided at the slide door 20 so as to conform to the arrangement of the latch mechanism 70 of the fully open lock 34. The second clutch C2 is operated in the similar ay to that in the rear lock 33 under a condition that “opening” and “closing” in the rear lock 33 are replaced with “closing” and “opening” in the fully open lock 34.

In this case, in addition to the similar effects to the effects (1)-(3), (5)-(11) of the aforementioned embodiment, the second clutch C2 is switchable between the connection state and the disconnection state by the interlocking lever 81 which is independently provided from the latch 73. Thus, degree of freedom of the configuration or arrangement of the latch mechanism, for example, improves.

The interlocking lever 81 related to the operation of the second clutch C2 may be provided at the front lock 32 instead of the rear lock 33. In addition, instead of the construction where the fully open lock includes the latch mechanism, a construction where the slide door 20 is simply held in the fully open state by using the inertia motion in association with the opening operation of the slide door 20 (stopper, for example) is considered. In this case, an interlocking structure of a fully open lock side and the second clutch C2 may be omitted. Further, the interlocking between the second clutch C2 and the interlocking lever 81 may be performed by a transmission structure of a link lever or a belt, for example, instead of the door position interlocking cable.

The second clutch-side lost motion at the second switching lever 62, i.e., the extension portion of the large diameter groove 63a, may be omitted by specifying the second clutch-side lost motion at the interlocking lever 81. The circumferential length of the large diameter groove 63a may be equal to that of the small diameter groove 63b. As illustrated in FIG. 11, an interlocking mechanism including a link mechanism 85 that operates on a basis of the opening and closing position of the slide door 20, i.e., a clearance Δ between the vehicle body 10 and the slide door 20, may be employed. The link mechanism 85 is provided between the vehicle body 10 and the slide door 20. The link mechanism 85 includes a cylindrical holder 86 provided facing a vehicle interior, a piston 87 in a pin form penetrating through the holder 86 and an interlocking lever 88 in a plate form. The interlocking lever 88 is supported relative to the slide door 20 to be rotatable around an axis which extends in an up-down direction. The interlocking lever 88 includes a connection piece 88a and an interlocking piece 88b extending from the axis in the radial direction.

The connection piece 88a of the interlocking lever 88 is connected to a tip end of the piston 87. The interlocking lever 88 rotates in the counterclockwise rotation direction and the clockwise rotation direction so as to cause the piston 87 to enter and retract relative to the holder 86. The interlocking lever 88 is configured so that the piston 87 protrudes from holder 86 in an initial state where the interlocking lever 88 is released from an external three. In addition, the interlocking piece 88b of the interlocking lever 88 is connected to the end of the door position interlocking cable 65. Thus, the arm portion 64 of the second switching lever 62 receives the engagement and disengagement operation force via the door position interlocking cable 65 based on the opening and closing position (opening and closing state) of the slide door 20. The link mechanism 85, the door position interlocking cable 65 and the arm portion 64 constitute the interlocking mechanism. In a case where the interlocking lever 88 is in the initial state, the tip end of the piston 87 that protrudes from the holder 86 is contactable with an edge portion of the door opening 10a in association with the closing operation of the slide door 20. In a case where the distance of the clearance Δ decreases below a predetermined distance with the closing operation of the slide door 20 from the open state thereof, the piston 87 that makes contact with the edge portion of the door opening 10a starts retracting from the holder 86. The interlocking lever 88 starts rotating in the clockwise rotation direction. At this time, the arm portion 64 is pressed by the door position interlocking cable 65 so that the second switching lever 62 also starts rotating. Then, when the slide door 20 approaches the half closed state, the second switching lever 62 rotates by an angle corresponding to the distance of the clearance Δ at this time and the second clutch C2 is brought to the connection state,

After the second clutch C2 is switched to the connection state, the second switching lever 62 is pressed by the door position interlocking cable 65 in association with the further closing operation of the slide door 20, i.e., decrease of the distance of the clearance Δ, so as to keep rotating. Nevertheless, because the second clutch-side lost motion is performed, the connection state of the second clutch C2 is maintained.

On the other hand, in a case where the engagement between the engagement end portion 74a of the pawl 74 and the fully latched engagement surface 73e of the latch 73 is released, the slide do 20 starts opening while the striker 75 is retracting from the engagement recess portion 73a. Then, the interlocking lever 88 which attempts to return to the initial state with the increase of the distance of the clearance Δ starts rotating while the piston 87 protrudes from the holder 86. The arm portion 64 is pulled by the door position interlocking cable 65 so that the second switching lever 62 starts rotating. When the slide door 20 operates beyond the half closed state, the second switching lever 62 rotates by an angle corresponding to the distance of the clearance Δ at this time. The second clutch C2 is brought to the disconnection state accordingly.

In this case, in addition to the similar effects to the effects (1)-(3), (5)-(11) of the aforementioned embodiment, the second clutch C2 is switchable between the connection state and the disconnection state, without being restricted by the rear lock 33, by the usage of the link mechanism 85 provided between the vehicle body 10 and the slide door 20.

The clearance between the vehicle body 10 and the slide door 20 related to the operation of the link mechanism 85 may be a clearance in the front-rear direction. The interlocking between the second clutch C2 and the link mechanism 85 may be a link lever or a belt, for example, instead of the door position interlocking cable.

The latch 73 (interlocking piece 73g) related to the operation of the second clutch C2 may be provided at the front lock 32 instead of the rear lock 33. Instead of the construction where the fully open lock includes the latch mechanism, a construction where the slide door 20 is simply held in the fully open state by using the inertia motion in association with the opening operation of the slide door 20 (stopper, for example) is considered. In this case, interlocking structure of the fully open lock side and the second clutch C2 may be omitted.

The interlocking between the second clutch C2 and the latch 73 may be performed by a link lever or a belt, for example, instead of the door position interlocking cable. The second clutch-side lost motion is provided at the second clutch C2 (second switching lever 62). Instead, the second clutch-side lost motion may be provided at the latch 73.

A point at which the second clutch C2 is switched between the connection state and the disconnection state includes a margin of a predetermined interval for the actual half closed state or open-side half closed state of the slide door 20 (for the state here the latch 73 is half latched). In this case, however, the second clutch C2 is desirably in the connection state within a range from a slightly open side relative to the half closed state to the fully open state or a range from a slightly closed side relative to the open-side half closed state to the fully open state.

The two cables constituted by the first cable 24 and the second cable 25 are utilized, however, the single cable may be employed. The drive member 21 may be fixed to the vehicle body 10. In a case where the drive member 21 is mounted to the quarter panel 10b, the tensioners 28 and 29 are desirably connected to the drive member 21. In a case where the drive member 21 is mounted to a step for the door opening 10a, a belt pulley and a belt are desirably employed. In this case, it may be desirable that the front lock 32 and the like are mounted to the vehicle body 10 and also the striker 75 is mounted to the slide door 20.

1. A door opening and closing apparatus for a vehicle, comprising:
a door lock configured to hold a vehicle door in a fully closed state or a half closed state;
an output member connected to the door lock and rotating in one direction for operating the door lock to bring the vehicle door from the half closed state to the fully closed state, the output member rotating in the other direction for operating the door lock to bring the vehicle door from the fully closed state to the half closed state;
a motor; and
a locking clutch serving as a mechanical clutch and connecting and disconnecting a rotation transmission between the motor and the output member, wherein
the door opening and closing apparatus for the vehicle is configured to electrically open and close the vehicle door in a range from an open state to the half closed state,
the door opening and closing apparatus for the vehicle further includes an interlocking mechanism switching the locking clutch to a connection state of the rotation transmission by interlocking with a state of the vehicle door positioned in a range from the fully closed state to the half closed state and switching the locking clutch to a disconnection state of the rotation transmission by interlocking with a state of the vehicle door positioned in a range where the vehicle door is opened relative to the half closed state.

2. The door opening and closing apparatus for the vehicle according to claim 1, wherein the interlocking mechanism is provided with a lost motion that cancels an operation relative to the locking clutch which is switched to the connection state of the rotation transmission in a case where the vehicle door is opened and closed between the fully closed state and the half closed state.

3. The door opening and closing apparatus for the vehicle according to either claim 1, comprising:
a pulley rotating to move a rope member for opening and closing the vehicle door; and
an opening and closing clutch connecting and disconnecting a rotation transmission between the motor and the pulley.

4. The door opening and closing apparatus for the vehicle according to claim 1, wherein
the door lock includes:
a latch provided to be rotatable at one of a vehicle body and the vehicle door, the latch holding the vehicle door in the fully closed state by engaging with a striker which is fixed to the other of the vehicle body and the vehicle door in a case where the latch is arranged at a fully latched position, the latch holding the vehicle door in the half closed state by engaging with the striker in a case where the latch is arranged at a half latched position; and
a pawl restricting a rotation of the latch arranged at the fully latched position or the half latched position,
the interlocking mechanism switches the locking clutch between the connection state and the disconnection state of the rotation transmission by interlocking with the rotation of the latch.

5. The door opening and closing apparatus for the vehicle according to claim 1, wherein
the door lock includes:
a latch provided to be rotatable at one of a vehicle body and the vehicle door, the latch holding the vehicle door in the fully closed state by engaging with a striker which is fixed to the other of the vehicle body and the vehicle door in a case where the latch is arranged at a fully latched position, the latch holding the vehicle door in the half closed state by engaging with the striker in a case where the latch is arranged at a half latched position; and
a pawl restricting a rotation of the latch arranged at the fully latched position or the half latched position,
the interlocking mechanism includes an interlocking lever provided to be rotatable at the vehicle body or the vehicle door including the latch, the interlocking lever rotating on a basis of an engagement position of the striker relative to the latch,
the interlocking mechanism switches the locking clutch between the connection state and the disconnection state of the rotation transmission by interlocking with a rotation of the interlocking lever.

6. The door opening and closing apparatus for the vehicle according to claim 1, wherein
the interlocking mechanism includes a link mechanism provided between a vehicle body and the vehicle door, the link mechanism operating on a basis of a clearance between the vehicle body and the vehicle door,
the interlocking mechanism switches the locking clutch between the connection state and the disconnection state of the rotation transmission by interlocking with an operation of the link mechanism.
